(19) United States
(12) Patent Application Publication
(10) Pub. No.: US 2020/0108359 A1
(43) Pub. Date: Apr. 9, 2020

(54) HYDROGEN WATER GENERATOR, MICRO/NANO HYDROGEN BUBBLE WATER GENERATOR AND MICRO/NANO HYDROGEN BUBBLE PRODUCTION WATER METHOD

(71) Applicant: U HYDROGEN TECHNOLOGIES CO., LTD., TAIPEI CITY (TW)

(72) Inventors: JUNG-KUEI CHANG, TAIPEI CITY (TW); YU-CHOU TSAI, TAOYUAN CITY (TW)

(21) Appl. No.: 16/154,955

(22) Filed: Oct. 9, 2018

(51) Int. Cl. B01F 5/04; B01F 3/04; B01F 3/20; C02F 1/28; C25B 1/04

(52) U.S. Cl. CPC B01F 5/0428; B01F 3/04503; B01F 3/2057; C02F 1/285; B01F 2215/0422; B01F 2003/04914; B01F 2003/04858; B01F 2215/0431; C25B 1/04

(57) ABSTRACT

The present disclosure illustrates a hydrogen water generator, a micro/nano hydrogen bubble water generator and a micro/nano hydrogen bubble water production method. The hydrogen water generator of the present disclosure receives water and hydrogen gas, and five sections are formed inside the main body of the hydrogen water generator, so as to mix the hydrogen gas and the water to produce hydrogen water, without using a compressor to pressure the hydrogen gas. The water flows to a pressuring section via a liquid input section, and is pressured by a pressuring section and the pressured water further flows to a draining and mixing section to be mixed with the hydrogen gas. The water mixed with hydrogen gas flows to a decompressing section to be decompressed, and then passes a hydrogen water output section to output hydrogen water with micro/nano hydrogen bubbles.

### BACKGROUND

### 1. Technical Field

The present disclosure relates a hydrogen water production technology, in particular, to a hydrogen water generator, a micro/nano (i.e. micro or nano) hydrogen bubble water generator and a micro/nano hydrogen bubble water production method, which pressure hydrogen gas, hit hydrogen gas molecule groups to produces amount of micro/nano hydrogen bubbles, and form the hydrogen water, without a compressor, wherein the micro/nano hydrogen bubbles are prone to dissolve in the water.

### 2. Description of Related Art

Academic articles have described that hydrogen gas has a certain health care effect on human body. Even, research results of articles show that the hydrogen gas has an obvious effect for improving agriculture and aquaculture. Regarding a general absorption manner, mostly, the hydrogen gas is dissolved in water to produce hydrogen water, and then the hydrogen water is drunk or sprayed; or alternatively, the hydrogen gas is directly breathed into the human body for absorption. The above two absorption manners are performed by directly absorbing hydrogen gas molecules.

During process of preparing hydrogen water, the conventional manner is to inject hydrogen gas directly to drink water, but due to the limited solubility of the hydrogen gas in the water, it needs a long time to dissolve expected amount of the hydrogen gas in the water, and the hydrogen gas in the water may quickly dissipate as time advances. Therefore, it is hard to reserve the hydrogen water, and the actual solubility of the hydrogen gas in the water is far less the expected value.

To solve the above problems, another conventional manner is to utilize a hydrogen gas compressor to compress the hydrogen gas, and to make the compressed hydrogen gas pass a plate body with micro holes, such that the hydrogen gas can reach the bucket and be dissolved in the water. However, a high pressure compressor may have dangers since it may cause spark easily and have flammability. Therefore, to avoid the above dangers, the conventional hydrogen gas compressor needs a certain volume and space, which causes the high cost of the hydrogen gas compressor as well as the increased production cost of the hydrogen water.

Additionally, another conventional manner is to utilize an ultra-sonic oscillation sheet to oscillate on the water, to decompose the hydrogen gas into smaller molecules by using the oscillation energy, such that the hydrogen gas can be quickly dissolved in the water. However, the ultra-sonic oscillation sheet requires higher oscillation frequency, and if the volume of the ultra-sonic oscillation sheet is too large, the higher oscillation frequency cannot be obtained. Thus, the generally used ultra-sonic oscillation sheet has the smaller area, and cannot produce large amount of micro/nano hydrogen bubble water via the hydrogen gas in a short time, which has limitation in usage.

### SUMMARY

To solve the above problems of the prior art, a main objective of the present disclosure is to provide a hydrogen water generator, a micro/nano hydrogen bubble water generator and a micro/nano hydrogen bubble water production method, which hit hydrogen gas molecule groups to produces amount of micro/nano hydrogen bubbles without using additional the compressor to compress the hydrogen gas, wherein the micro/nano hydrogen bubbles can be dissolved in the water quickly to generate hydrogen water with micro/nano hydrogen bubbles.

A sub-objective of the present disclosure is to provide a micro/nano hydrogen bubble water generator, wherein the filter module of the hydrogen gas production device filters the unfiltered water to decrease conductivity of the water, and thus the filtered water is substantially as same as the pure water. After the water is filtered and cycled continuously, the proton exchange membrane based hydrogen production module can be used to produce the high purity hydrogen gas and hydrogen water from the filtered water.

According to an objective of the present disclosure, a hydrogen water generator is provided, wherein the hydrogen water generator has a main body of a substantial T shape, a liquid input end and a hydrogen water output end are respectively disposed on two opposite ends of the main body, and a hydrogen gas input end is disposed between the liquid input end and the hydrogen water output end. Beginning from the liquid input end to the hydrogen water output end, a liquid input section, a pressuring section, a draining and mixing section, a decompressing section and a hydrogen water output section are sequentially formed in the main body, a hydrogen gas input section is formed between the hydrogen gas input end and the draining and mixing section, and a portion which the hydrogen gas input section is connected to the draining and mixing section forms a hydrogen gas inlet. A ratio of a diameter of the liquid input section over a diameter of the draining and mixing section is about 1.5 through 5, and a diameter of the hydrogen water output section is larger than a diameter of the draining and mixing section. A ratio of a length of the draining and mixing section over the diameter of the draining and mixing section is about 1.5 through 5, an inner wall tilting angel of the pressuring section is about 10 through 50 degrees, an inner wall tilting angel of the decompressing section is about 10 through 50 degrees, and a ratio of the inner wall tilting angel of the pressuring section over the inner wall tilting angel of the decompressing section is about 1 through 5, wherein a ratio of the diameter of the liquid input section over a diameter of the hydrogen gas inlet is about 3.25 through 650.

Regarding the above features, the ratio of the diameter of the liquid input section over the diameter of the draining and mixing section is about 2 through 4.

Regarding the above features, the ratio of the length of the draining and mixing section over the diameter of the draining and mixing section is about 2 through 4.

Regarding the above features, the inner wall tilting angel of the pressuring section is about 16 through 25 degrees.

Regarding the above features, the inner wall tilting angel of the decompressing section is about 14 through 25 degrees.

Regarding the above features, the ratio of the inner wall tilting angel of the pressuring section over the inner wall tilting angel of the decompressing section is about 1 through 1.5.

Regarding the above features, the diameter of the hydrogen gas inlet is about 0.01 through 2 millimeters.

According to an objective of the present disclosure, a micro/nano hydrogen bubble water generator at least comprising a hydrogen gas production device for producing hydrogen gas, a water supply device and the above hydrogen water generator is provided. The liquid input end of the hydrogen water generator is connected to the water supply device, and the hydrogen gas input end of the hydrogen water generator is connected to the hydrogen gas production device. After water provided by the water supply device flows to the pressuring section via the liquid input section, and is pressured by the pressuring section, the water further flows to the draining and mixing section to be mixed with hydrogen gas which passes the hydrogen gas input section. After the water mixed with the hydrogen gas passes the decompressing section, and decompressed by the decompressing section, the water is output via the hydrogen water output section and the hydrogen water output end, so as to produce hydrogen water with micro/nano hydrogen bubbles.

Regarding the above features, the water supply device comprises a water supply tank and a water pump, a water inlet end of the water pump is connected to the water supply tank, a water outlet end of the water pump is connected to the liquid input end of the hydrogen water generator, and the hydrogen water output end of the hydrogen water generator is connected to the water supply tank.

Regarding the above features, the water supply device comprises a housing, a water supply tank, a water pump and a water outlet device, the housing is provided to accommodate the hydrogen gas production device, the hydrogen water generator, the water supply tank and the water pump, a water inlet end of the water pump is connected to the water supply tank, a water outlet end of the water pump is connected to the liquid input end of the hydrogen water generator, and the hydrogen water output end of the hydrogen water generator is disposed corresponding to a hydrogen water tank in the housing, wherein the water outlet device is connected to the hydrogen water tank.

Regarding the above features, the water supply device comprises a housing, a water supply tank, a water pump and a water outlet device, the housing is provided to accommodate the hydrogen gas production device, the hydrogen water generator, the water supply tank and the water pump, a water inlet end of the water pump is connected to the water supply tank, and a water outlet end of the water pump is connected to the liquid input end of the hydrogen water generator and the water outlet device of the housing.

Regarding the above features, the micro/nano hydrogen bubble water generator further comprises a fuel tank connected to the hydrogen gas production device to provide fuel which the hydrogen gas production device produces the hydrogen gas.

Regarding the above features, the hydrogen gas production device further comprises a liquid/gas separation module, a proton exchange membrane based hydrogen production module, a power supply and control circuit module and a filter module, the proton exchange membrane based hydrogen production module and the liquid/gas separation module are connected to the filter module, and the liquid/gas separation module is connected to the hydrogen gas input end of the hydrogen water generator.

Regarding the above features, the filter module further comprises a main filter body, a water inlet is disposed on a top portion of the main filter body, a water outlet is disposed on a bottom portion of the filter body, a plurality of nuclear-grade resin filter bodies are disposed in the main filter body, after the unfilered water flows to the water inlet, and the nuclear-grade resin filter body absorbs impurity of the water and decreases conductivity of the water, the filtered water is supplied to the proton exchange membrane based hydrogen production module.

Regarding the above features, the main filter body further comprises a water inlet cover connected to a water supply end, and the water inlet cover further comprises the water inlet. The main filter body further comprises an outer ring body, an inner ring body and a spacing unit, the outer ring body further has an installation space which is provided to combine the inner ring body and the spacing unit, the water outlet is disposed on a bottom portion of the outer ring body, and the water inlet cover is connected to a top portion of the outer ring body. The inner ring body is disposed on the space unit and combined with interior of the installation space, and the spacing unit separates the inner ring body and the outer ring body with a distance. Drip holes are disposed on a bottom portion of the inner ring body, the inner ring body is correspondingly combined with a filter fixing plate, a first water filtering space is formed between the filter fixing plate and the water inlet cover, the filter fixing plate and the bottom portion of the inner ring body have a distance therebetween and thus a second water filtering space is formed, and the nuclear-grade resin filter bodies are disposed in the second water filtering space.

Regarding the above features, a ratio of a diameter of the outer ring body over a height of the outer ring body is less than 0.9.

Regarding the above features, a diameter of the drip hole of the inner ring body is about 0.8 through 1.5 millimeters.

Regarding the above features, the main filter body further comprises a water inlet cover connected to a water supply end, the water inlet cover further comprises the water inlet, and a connection tube is disposed under the water inlet. The main filter body further comprises an outer ring body and an inner ring body; the outer ring body further comprises an installation space which is provided to combine the inner ring body, the water outlet is disposed on a bottom portion of the outer ring body, and further, the water inlet cover is connected to a top portion of the outer ring body. The inner ring body is a spiral inner ring, and the spiral inner ring has a spiral tube, and a top portion of the spiral inner ring is connected to the connection tube, and interior of the spiral inner ring has the nuclear-grade resin filter bodies, a bottom portion of the spiral inner ring is connected with the water outlet of the outer ring body. The connection tube has a taper section for guiding.

According to an objective of the present disclosure, a micro/nano hydrogen bubble water production method is provided, and the method comprises steps as follows. A liquid input end of a hydrogen water generator is used to receive water supplied from a water supply device, such that the water flows to a liquid input section of the hydrogen water generator. When water flows to a pressuring section of the hydrogen water generator via the liquid input section, the water is pressured by the pressuring section, and then the pressured water flows to a draining and mixing section of the hydrogen water generator. Hydrogen gas supplied from a hydrogen gas production device is drained via a hydrogen gas input end of the hydrogen water generator, such that the hydrogen gas passes a hydrogen gas input section of the hydrogen water generator and flows to a draining and mixing section of the hydrogen water generator, thus draining the hydrogen gas into the water for mixing. When the water mixed with the hydrogen gas flows to a decompressing section of the hydrogen water generator via the draining and mixing section, the decompressing section decompresses the water with the hydrogen gas, so as to generate hydrogen water with micro/nano hydrogen bubbles. The hydrogen water with the micro/nano hydrogen bubbles are output by sequentially passing the hydrogen water output section of the hydrogen water generator and the hydrogen water output end.

Regarding the above method, the ratio of the diameter of the liquid input section over the diameter of the draining and mixing section is about 2 through 4.

Regarding the above method, the ratio of the length of the draining and mixing section over the diameter of the draining and mixing section is about 2 through 4.

Regarding the above method, the inner wall tilting angel of the pressuring section is about 16 through 25 degrees.

Regarding the above method, the inner wall tilting angel of the decompressing section is about 14 through 25 degrees.

Regarding the above method, the ratio of the inner wall tilting angel of the pressuring section over the inner wall tilting angel of the decompressing section is about 1 through 1.5.

Regarding the above method, the diameter of the hydrogen gas inlet is about 0.01 through 2 millimeters.

Accordingly, the hydrogen water generator, the micro/nano hydrogen bubble water generator and the micro/nano hydrogen bubble water production method further has the following advantages:

(1) The hydrogen water generator of the present disclosure is utilized to receive water and hydrogen gas, and by using the formed inner structure of the main body of the hydrogen water generator, the hydrogen gas molecule groups are hit to divide into micro/nano bubbles, such that amount of bubbles and water are mixed to produce the hydrogen water via the hydrogen gas without additional pressuring, the compressor is not required, and the processing cost of the preparing the hydrogen water can be decreased.

(2) Since the hydrogen water generator of the present disclosure can hit the hydrogen gas molecule groups to divide into micro/nano bubbles, and the micro/nano bubbles have better mass transfer and slower dissipation, such properties not only accelerate the dissolving speed of the hydrogen gas in the water, but also complete the preparing of the hydrogen water ins a short time, even further the reservation time of the hydrogen gas in the hydrogen water is increased.

(3) By dissolving the hydrogen gas in the water to quickly produce the hydrogen water with a higher solubility and integrating the hydrogen water generator with the water drinking device, the hydrogen water can be provided to the user to drink, and thus making the user quickly absorb the beneficial substances in the hydrogen water.

(4) By using the filter module of the hydrogen gas production device to filter the unfiltered water, the conductivity of the water is decreased, the filter water can be the same as the pure water, and after the water is cycled and filtered continuously, the proton exchange membrane based hydrogen production module can produce amount of the hydrogen gas with high purity and the hydrogen water, from the filtered water.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a section view of a hydrogen water generator of the present disclosure.

FIG. 2 is a schematic view of a micro/nano hydrogen bubble water generator of a first embodiment.

FIG. 3 is a first schematic view of a micro/nano hydrogen bubble water generator of the present disclosure.

FIG. 4 is a second schematic view of a micro/nano hydrogen bubble water generator of the present disclosure.

FIG. 5 is a third schematic view of a micro/nano hydrogen bubble water generator of the present disclosure.

FIG. 6 is a flow chart of a micro/nano hydrogen bubble water production method of the present disclosure.

FIG. 7 is a schematic view of a micro/nano hydrogen bubble water generator of a second embodiment.

FIG. 8 is a three-dimensional view of a filter module of a micro/nano hydrogen bubble water generator of the present disclosure.

FIG. 9 is a usage view of a filter module of a micro/nano hydrogen bubble water generator of the present disclosure.

FIG. 10 is a three-dimensional view of another filter module of a micro/nano hydrogen bubble water generator of the present disclosure.

### DESCRIPTION OF THE EXEMPLARY EMBODIMENTS

To understand the technical features, content and advantages of the present disclosure and its efficacy, the present disclosure will be described in detail with reference to the accompanying drawings. The drawings are for illustrative and auxiliary purposes only and may not necessarily be the true scale and precise configuration of the present disclosure. Therefore, the scope of the present disclosure should not be limited to the scale and configuration of the attached drawings.

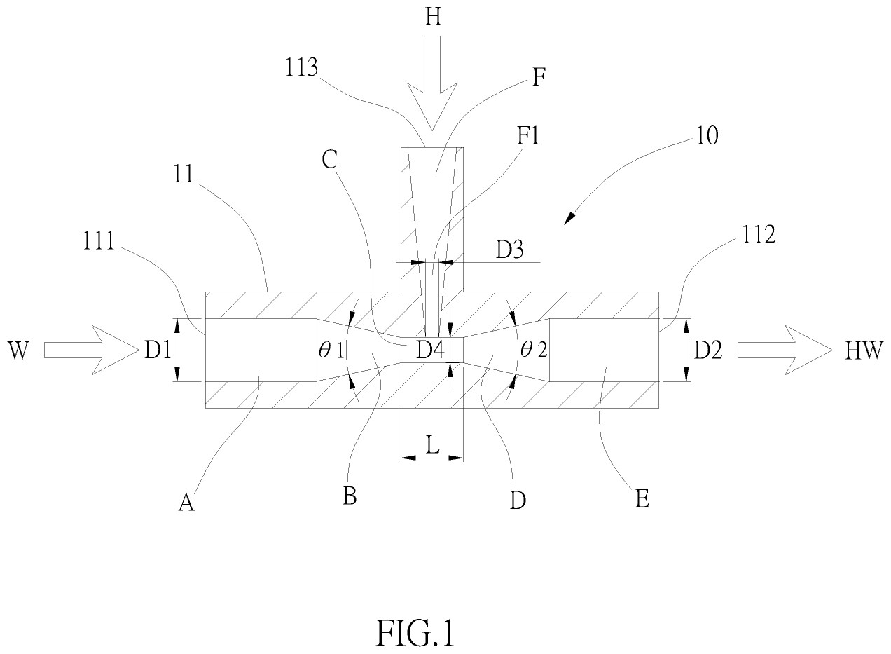

The hydrogen water generator of the present disclosure can drain hydrogen gas by a draining force which is generated since the liquid flows to a pipe with a smaller section area from a pipe with a larger section area, and hit the hydrogen gas molecule groups to divide into micro/nano bubbles by the liquid flowing speed, such that the hydrogen gas and the liquid can have a better liquid/gas mixing effect to prepare the hydrogen water. Referring to FIG. 1, FIG. 1 is a section view of a hydrogen water generator of the present disclosure. As shown in FIG. 1, the hydrogen water generator 10 of the present disclosure has a main body 11 of a substantial T shape. A liquid input end 111 and a hydrogen water output end 112 are respectively disposed on two opposite ends of the main body 11, wherein the liquid input end 111 receives water W, and hydrogen water output end 112 outputs hydrogen water HW. A hydrogen gas input end 113 is disposed between the liquid input end 111 and the hydrogen water output end 112, wherein the hydrogen gas input end 113 receives hydrogen gas H. Further, beginning from the liquid input end 111 to the hydrogen water output end 112, a liquid input section A, a pressuring section B, a draining and mixing section C, a decompressing section D and a hydrogen water output section E are sequentially formed in the main body 11. The hydrogen gas input section F is formed between the hydrogen gas input end 113 and the draining and mixing section C, and a portion which the hydrogen gas input section F is connected to the draining and mixing section C forms a hydrogen gas inlet F1.

When the hydrogen water generator 10 is used to prepare the hydrogen water HW, the liquid input end 111 receives the water W, and the water W flows to the liquid input section A. Then, while the water W flows to the pressuring section B via the liquid input section A, the pressuring section B pressures the water W, and then the water W further flows to the draining and mixing section C. Since the water W flows from a pipe with a larger section area to a pipe with a smaller section area, a draining force is thus induced to drain the hydrogen gas H flowing to the hydrogen gas inlet F1 of the hydrogen gas input section F into the water W. Meanwhile, the flowing speed of the water W can hit the gas molecule groups of the hydrogen gas H to divide into micro/nano hydrogen bubbles, and thus the hydrogen gas H can be mixed with the water in the draining and mixing section C. Next, the water W mixed with the hydrogen gas H passes the decompressing section D and decompressed by the decompressing section D, and then the hydrogen water HW with the micro/nano hydrogen bubbles can be output via the hydrogen water output section E and the hydrogen water output end 112.

The diameter D1 of the liquid input section A and the diameter D2 of the hydrogen water output section E are larger than the diameter D4 of the draining and mixing section C. A ratio of the diameter D1 of the liquid input section A over the diameter D4 of the draining and mixing section C is about 1.5 through 5, and preferably, 2 through 4. A ratio of the length L of the draining and mixing section C over the diameter D4 of the draining and mixing section C is about 1.5 through 5, and preferably, 2 through 4. The inner wall tilting angle θ1 of the pressuring section B is about 10 through 50 degrees, and preferably, 16 through 25 degrees. The inner wall tilting angle θ2 of the decompressing section D is about 10 through 50 degrees, and preferably, 14 through 25 degrees. A ratio of the inner wall tilting angle θ1 of the pressuring section B over the inner wall tilting angle θ2 of the decompressing section D is about 1 through 5, and preferably, 1 through 1.5. A ratio of the diameter D1 of the liquid input section A over the diameter D3 of the hydrogen gas inlet F1 is about 3.25 through 650. The diameter D3 of the hydrogen gas inlet F1 can be 0.1 through 2 millimeters, and preferably, 0.4 through 1.5 millimeters.

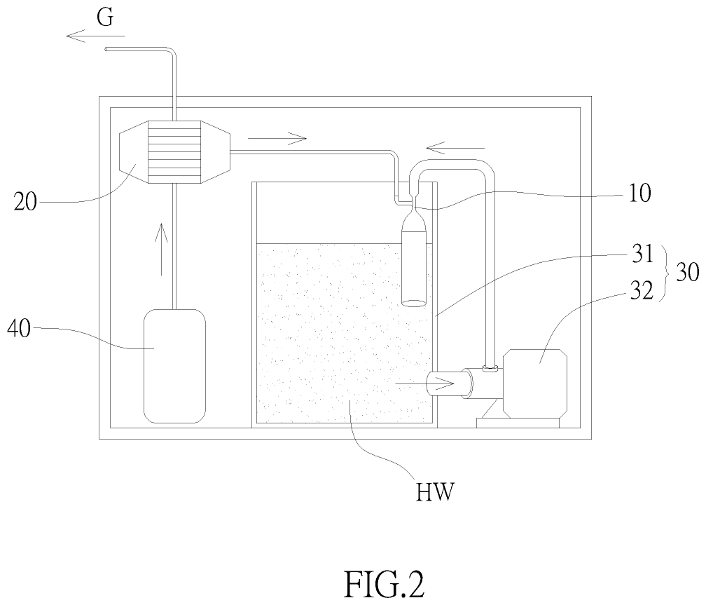

Moreover, referring to FIG. 1 and FIG. 2 simultaneously, FIG. 2 is a schematic view of a micro/nano hydrogen bubble water generator of a first embodiment. As shown in FIG. 2, the micro/nano hydrogen bubble water generator of the present disclosure comprises the hydrogen water generator 10 as mentioned above, and further comprises a hydrogen gas production device 20, a water supply device 30 and a fuel tank 40. The hydrogen gas production device 20 is connected to the hydrogen gas input end 113 of the hydrogen water generator 10 and the fuel tank 40. The water supply device 30 is connected to the liquid input end 111 of the hydrogen water generator 10. Furthermore, the water supply device 30 further comprises a water supply tank 31 and a water pump 32. A water inlet end of the water pump 32 is connected to the water supply tank 31, a water outlet end of the water pump 32 is connected to the liquid input end 111 of the hydrogen water generator 10, and the hydrogen water output end 112 of the hydrogen water generator 10 is connected to the water supply tank 31. The fuel tank 40 can further have hydrogen production fuel, such as petrochemical fuel, pure water for electrolysis and electrolyte. When the fuel tank 40 sends the fuel to the hydrogen gas production device 20, the hydrogen gas production device 20 can exhaust the unwanted exhaust gas G, and the hydrogen gas H can be sent to the hydrogen water generator 10. By using the hydrogen water generator 10 to continuously mix the water W and the hydrogen gas H in an open or close cycling manner, the hydrogen water HW with the micro/nano hydrogen bubbles can be stored in the water supply tank 31.

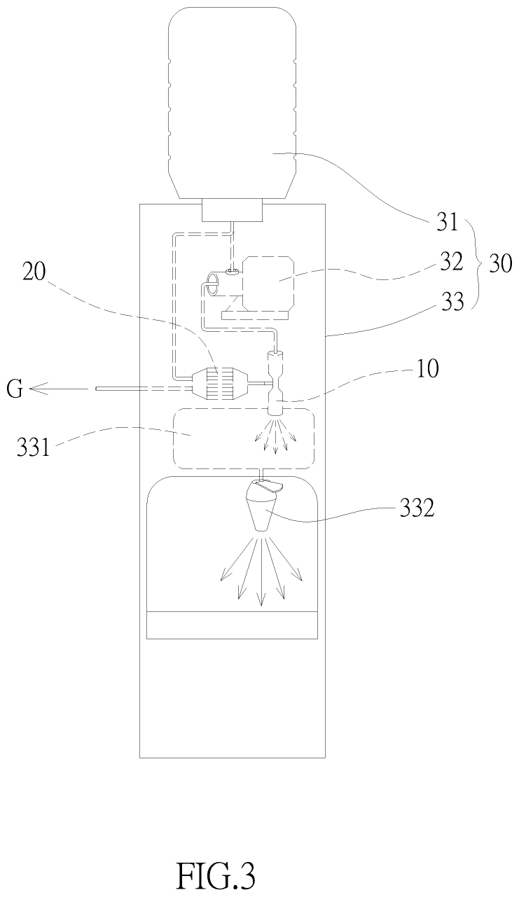

Further, referring to FIG. 1 and FIG. 3, FIG. 3 is a first schematic view of a micro/nano hydrogen bubble water generator of the present disclosure. The micro/nano hydrogen bubble water generator of the present disclosure comprises the above hydrogen water generator 10, and further comprises a hydrogen gas production device 20 and a water supply device 30, wherein the water supply device 30 comprises a water supply tank 31, a water pump 32 and a housing 33. The housing 33 is provided to accommodate the hydrogen gas production device 20, the hydrogen water generator 10, the water supply tank 31 and the water pump 32. The hydrogen gas production device 20 is connected to the hydrogen gas input end 113 of the hydrogen water generator 10, a water inlet end of the water pump 32 is connected to the water supply tank 31, a water outlet end of the water pump 32 is connected to the liquid input end 111 of the hydrogen water generator 10, and the hydrogen water output end 112 of the hydrogen water generator 10 is connected to a hydrogen water tank 331 of the housing 33. The hydrogen gas input end 113 of the hydrogen water generator 10 can receives the hydrogen gas provided by the hydrogen gas production device 20, and the water pump 32 pumps the water in the water supply tank 31 to the liquid input end 111 of the hydrogen water generator 10. By using the hydrogen water generator 10, the hydrogen gas H and the water W are mixed to produce the hydrogen water HW, and then the hydrogen water HW is output to the hydrogen water tank 331 of the housing 33, wherein the water outlet device 332 is connected to and disposed on the hydrogen water tank 331. When the user opens the water outlet device 332 of the housing, she or he can acquire the hydrogen water HW stored in the hydrogen water tank 331, wherein the water supply tank 31 can be the water storage tank of the water drinking device.

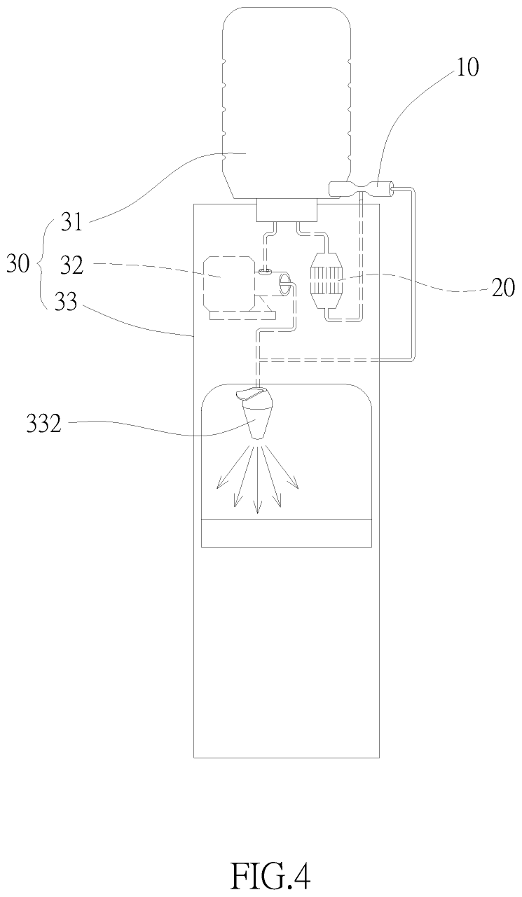

Further, referring to FIG. 1 and FIG. 4, FIG. 4 is a second schematic view of a micro/nano hydrogen bubble water generator of the present disclosure. As shown in FIG. 4, the micro/nano hydrogen bubble water generator of the present disclosure comprises the above hydrogen water generator 10, and further comprises a hydrogen gas production device 20 and a water supply device 30, wherein the water supply device 30 comprises a water supply tank 31, a water pump 32 and a housing 33. The housing 33 is provided to accommodate the hydrogen gas production device 20, the hydrogen water generator 10, the water supply tank 31 and the water pump 32. The hydrogen gas production device 20 is connected to the hydrogen gas input end 113 of the hydrogen water generator 10, an water inlet end of the water pump 32 is connected to the water supply tank 31, an outlet end of the water pump 32 is connected to the liquid input end 111 of the hydrogen water generator 10 and a water outlet device 332 corresponding to the housing 33. The hydrogen water output end 112 of the hydrogen water generator 10 is connected to the water supply tank 31. In the embodiment, by using the close cycling manner, the hydrogen water HW is continuously produced in the water supply tank 31, so as to increase the hydrogen purity of the hydrogen water HW. When the user opens the water outlet device 332 of the housing, she or he can acquire the hydrogen water HW stored in the hydrogen water tank 33, wherein the water supply tank 31 can be the water storage tank of the water drinking device.

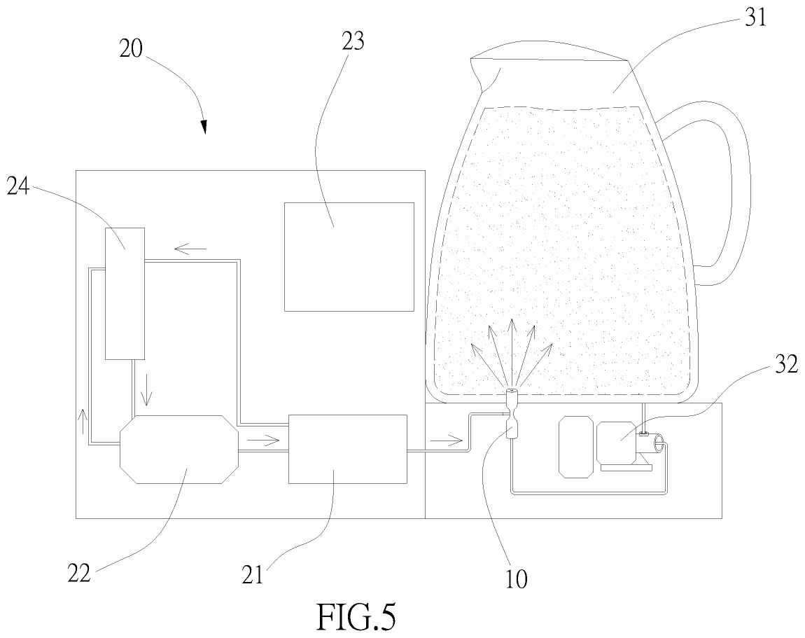

Further, referring to FIG. 1 and FIG. 5, FIG. 5 is a third schematic view of a micro/nano hydrogen bubble water generator of the present disclosure. As shown in FIG. 5, the micro/nano hydrogen bubble water generator comprises the above hydrogen water generator 10, and further comprises a hydrogen gas production device 20 and a water supply device 30. The hydrogen gas production device 20 can be anyone type of the hydrogen gas production device, and the present disclosure is not limited thereto. In one preferred embodiment of the present disclosure, the hydrogen gas production device 20 comprises a liquid/gas separation module 21, a proton exchange membrane based hydrogen production module 22, a power supply and control circuit module 23 and a filter module 24. The power supply and control circuit module 23 is disposed in the hydrogen gas production device 20, and electrically connected to each component of the hydrogen gas production device 20, to provide electricity to the components of the hydrogen gas production device 20, and to control the components of the hydrogen gas production device 20 to be turned on or off The proton exchange membrane based hydrogen production module 22 and the liquid/gas separation module 21 are connected to the filter module 24 to form a close cycling loop. The liquid/gas separation module 21 is connected to the hydrogen gas input end 113 of the hydrogen water generator 10. Accordingly, after the proton exchange membrane based hydrogen production module 22 produces oxygen gas, hydrogen gas H and water W, the oxygen gas and a portion of the water W is guided back to the filter module 24 via the pipe. Next, the liquid/gas separation module 21 can separate the hydrogen gas H and the water W, the hydrogen gas H is input to the hydrogen gas input end 113 of the hydrogen water generator 10, and the residual portion of the water W is guided back to the filter module 24 via the pipe. By the filtering of the filter module 24, the filtered water W acts as a material source of the proton exchange membrane based hydrogen production module 22. By using the proton exchange membrane based hydrogen production module 22 to produce hydrogen, the purity of the hydrogen gas can reach more than 99.995%, and the produced hydrogen gas will not pollute the environment. The water supply device 30 comprises a water supply tank 31 and a water pump 32, the water inlet end of the water pump 32 is connected to the water supply tank 31, the water outlet end of the water pump 32 is connected to the liquid input end 111 of the hydrogen water generator 10, and the hydrogen water output end 112 of the hydrogen water generator 10 is connected to the water supply tank 31. The water supply tank 31 can be a portable water pot.

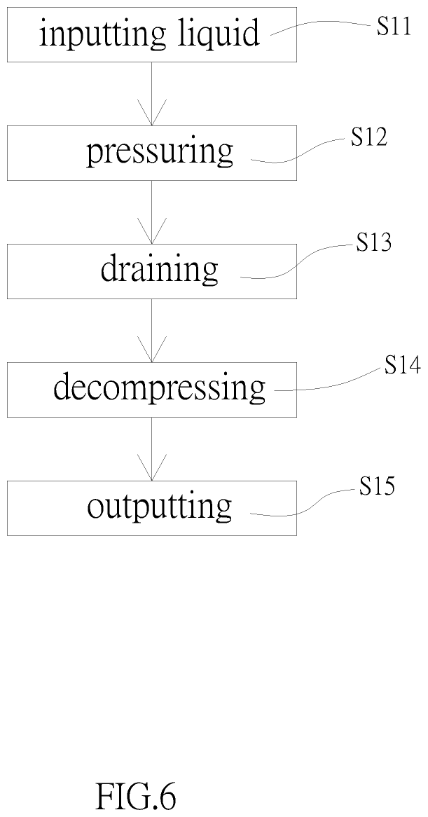

Referring to FIG. 1, FIG. 2 and FIG. 6, FIG. 6 is a flow chart of a micro/nano hydrogen bubble water production method of the present disclosure. The method comprises steps as follows.

Liquid inputting step S11: using a liquid input end 111 of a hydrogen water generator 10 to receive water W supplied from a water supply device, such that the water W flows to a liquid input section A of the hydrogen water generator 10.

Pressuring step S12: when water W flows to a pressuring section B of the hydrogen water generator 10 via the liquid input section A, pressuring the water W by using the pressuring section B, and making the pressured water W flow to a draining and mixing section C of the hydrogen water generator 10.

Draining step S13: draining hydrogen gas H supplied from a hydrogen gas production device 20 via a hydrogen gas input end 113 of the hydrogen water generator 10, such that the hydrogen gas H passes a hydrogen gas input section F of the hydrogen water generator 10 and flows to a draining and mixing section C of the hydrogen water generator 10, thus draining the hydrogen gas H into the pressured water W for mixing the hydrogen gas H and hitting the hydrogen gas molecule groups.

Decompressing step S14: when the water W mixed with the hydrogen gas H flows to a decompressing section D of the hydrogen water generator 10 via the draining and mixing section C, decompressing the water W with the hydrogen gas H, by using the decompressing section D, so as to generate hydrogen water HW with micro/nano hydrogen bubbles.

Outputting step S15: outputting the hydrogen water HW with the micro/nano hydrogen bubbles by sequentially passing the hydrogen water output section E of the hydrogen water generator 10 and the hydrogen water output end 112.

Specifically, in the present disclosure, by changing the section areas of the inner structure of the hydrogen water generator, the liquid is pressured, and the hydrogen gas is drained into the liquid. Meanwhile, the liquid flowing speed can hit the hydrogen gas molecule groups, and thus, without additional pressuring of the compressor, the amount of the micro/nano hydrogen bubble water is produce from the hydrogen gas, and quickly dissolved in the liquid. Since the micro/nano hydrogen bubble water has the better mass transfer and slower dissipation, the reservation time of the hydrogen gas in the hydrogen water can be increased.

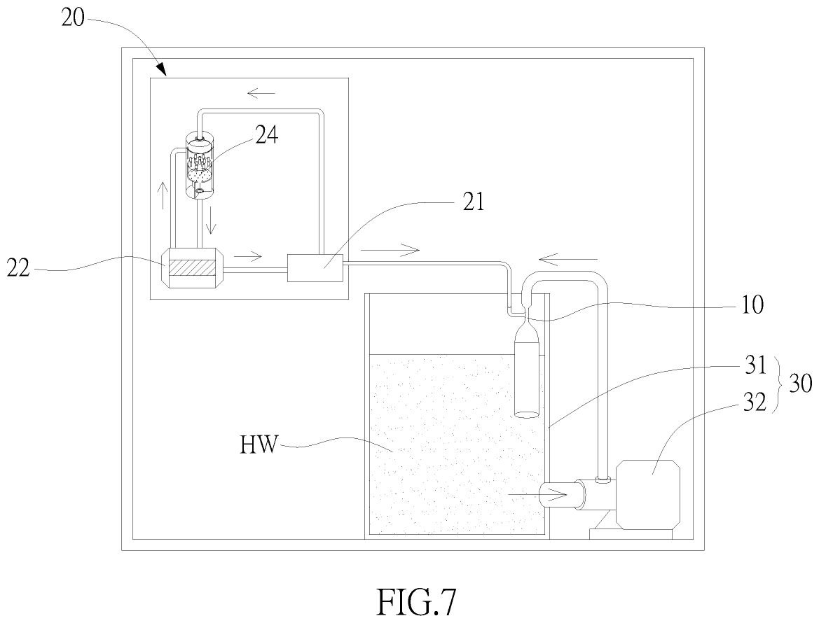

Next, referring to FIG. 1 and FIG. 7, FIG. 7 is a schematic view of a micro/nano hydrogen bubble water generator of a second embodiment. As shown in FIG. 7, the micro/nano hydrogen bubble water generator of the present disclosure comprises the above hydrogen gas production device 20, a hydrogen water generator 10 and a water supply device 30. The liquid/gas separation module 21 of the hydrogen gas production device 20 is connected to the hydrogen gas input end 113 of the hydrogen water generator 10. The water supply device 30 is connected to the liquid input end 111 of the hydrogen water generator 10. Further, the water supply device 30 further comprises a water supply tank 31 and a water pump 32, the water inlet end of the water pump 32 is connected to the water supply tank 31, the water outlet end of the water pump 32 is connected to the liquid input end 111 of the hydrogen water generator 10, and the hydrogen water output end 112 of the hydrogen water generator 40 is connected to the water supply tank 31. The hydrogen gas production device 20 can send the hydrogen gas H to the hydrogen water generator 10, and by using an open or close cycling manner to continuously mix the water W and the hydrogen water H, the hydrogen water HW with the micro/nano hydrogen bubble waters can be stored in the water supply tank 31.

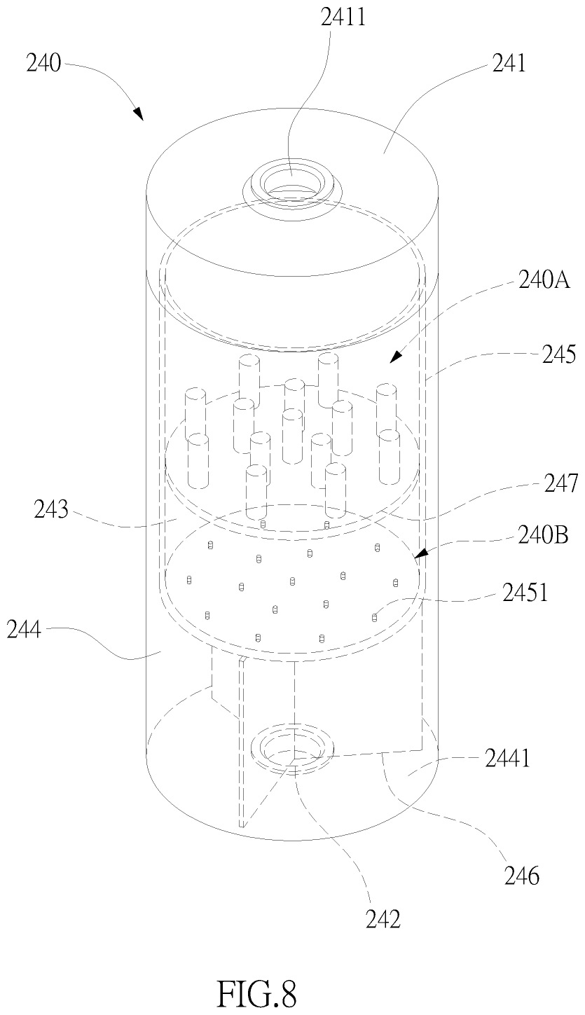

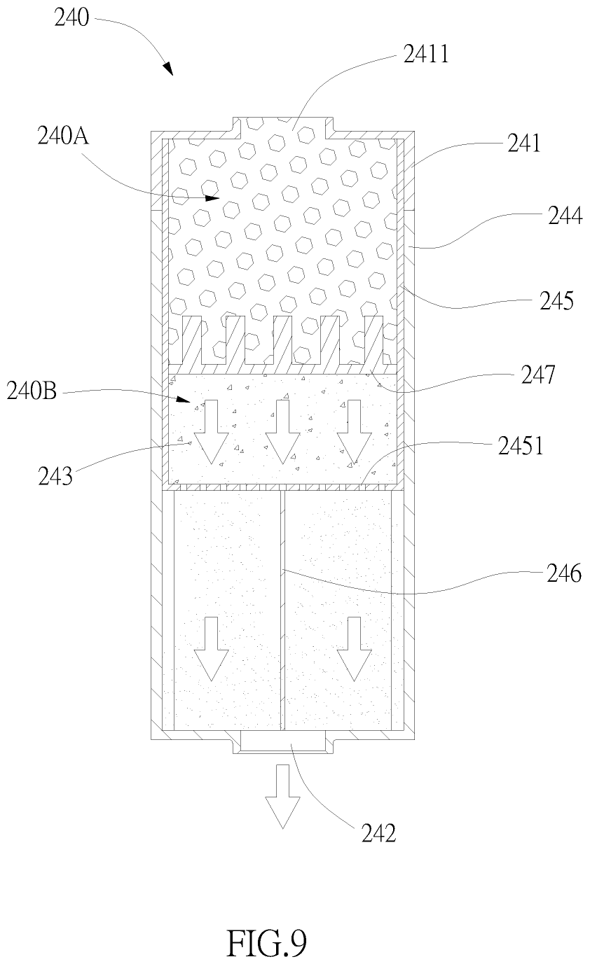

Referring to FIG. 8 and FIG. 9, FIG. 8 is a three-dimensional view of a filter module of a micro/nano hydrogen bubble water generator of the present disclosure, and FIG. 9 is a usage view of a filter module of a micro/nano hydrogen bubble water generator of the present disclosure. As shown in FIG. 8 and FIG. 9, the filter module 24 utilizes gravity for filtering, and thus it can further decrease the conductivity of the water. The filter module 24 further comprises a main filter body 240, and the main filter body 240 comprises a water inlet cover 241. The water inlet cover 241 is connected to a water supply end, and the water inlet cover 241 has a water inlet 2411 which provides a water tube or other connection component for guiding liquid. The main filter body 240 further comprises an outer ring body 244, an inner ring body 245 and a spacing unit 246. The outer ring body 244 further comprises an installation space 2441 which is provided to combine the inner ring body 245 and the spacing unit 246, and the water outlet 242 is disposed on a bottom portion of the outer ring body 244. The water inlet cover 241 is connected to a top portion of the outer ring body 244. The inner ring body 245 and the spacing unit 246 are combined in the installation space 2441, and the spacing unit 246 separates the inner ring body 245 and the outer ring body 244 with a distance. Drip holes 2451 are disposed on a bottom portion of the inner ring body 245. The inner ring body 245 is correspondingly combined with a filter fixing plate 247 therein. A first water filtering space 240A is formed between the filter fixing plate 247 and the water inlet cover 241. A bottom portion of the inner ring body 245 and the filter fixing plate 247 have a distance therebetween and thus a second water filtering space 240B is formed, and the nuclear-grade resin filter bodies 243 are disposed in the second water filtering space 240B. Accordingly, by using the filter module and each component of the micro/nano hydrogen bubble water generator, after the unfiltered water (such as tap water or mineral water) are filtered by the filter module, the conductivity of the water can be decreased, and the filtered water can be the same as the pure water. After the water is continuously filtered by a cycling manner, the proton exchange membrane based hydrogen production module can generate the amount of the high purity hydrogen gas and the hydrogen water, from the filtered water.

As shown in FIG. 9, when the water is guided to the first water filtering space 240A via the water inlet cover 241, the weight of the water makes the water flow to the second water filtering space 240B and pressure the water in the second water filtering space 240B. Next, the nuclear-grade resin filter bodies 243 in the second water filtering space 240B absorb the impurity of the water to decrease the conductivity of the water, and the filtered water is guided to the bottom portion of the outer ring body 244 via the drip holes 2451 of the inner ring body 245. The inner ring body 245 and the outer ring body 244 are separated from the spacing unit 246, and the water in the second water filtering space 240B is gradually dripped on the outer ring body 244 due to the gravity, so as to prevent the filtered water from being hoarded. The water outlet 242 of the outer ring body 244 can output the water, wherein the water outlet 242 is connected to the proton exchange membrane based hydrogen production module 22 via the pipe. Therefore, the conductivity of the water can be decreased after being filtered, and the filtered water is provided to the proton exchange membrane based hydrogen production module 22 for producing hydrogen.

As shown in FIG. 8 and FIG. 9, the time which the unfiltered water guided by the water inlet cover 241 contacts with the nuclear-grade resin filter body 243 extremely affects the filtering effect. In several experiments, it can be seen that the ratio of the diameter of the outer ring body 244 over the height of the outer ring body 244 should be less than 0.9. Since the ion absorption ability of the nuclear-grade resin filter bodies 243 is constant, the weight ratio of the water to be filtered over the filled resin should be less than 2. The water flowing speed in the nuclear-grade resin filter bodies 243 is preferably less than 1.3 cc/min. As shown in FIG. 8, the diameter of the drip hole 2451 of the inner ring body 245 is 0.8 through 1.5 millimeters, and there are 24 drip holes 2451 disposed on the bottom portion of the inner ring body 245.

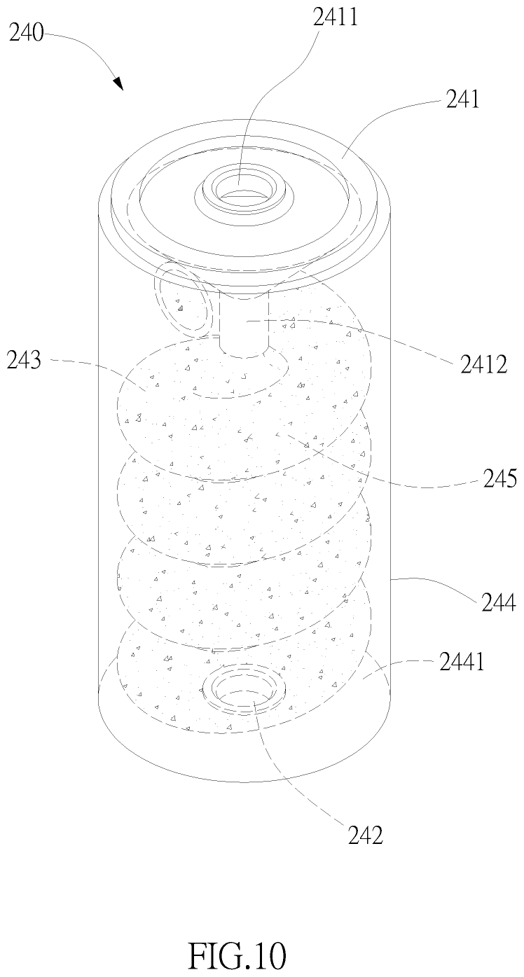

Referring to FIG. 10, FIG. 10 is a three-dimensional view of another filter module of a micro/nano hydrogen bubble water generator of the present disclosure. The main filter body 240 comprises a water inlet cover 241 connected to a water supply end. The water inlet cover 241 has a water inlet 2411, and connection tube 2412 is disposed under the water inlet 2411. The connection tube 2412 has a taper section for guiding. The main filter body 240 further comprises an outer ring body 244 and an inner ring body 245. The connection tube 2412 is combined on the inner ring body 245 of the main filter body 240, the outer ring body 244 has an installation space 2441 being provided to combine the inner ring body 245, the bottom portion of the outer ring body 244 has a water outlet 242, and the water outlet 242 is connected to the proton exchange membrane based hydrogen production module 22. A top portion of the outer ring body 244 is provided to connect the water inlet cover 241, wherein the inner ring body 245 is a spiral inner ring. The spiral inner ring has a spiral tube, and a top portion of the spiral inner ring is connected to the connection tube 2412. Interior of the spiral inner ring has the nuclear-grade resin filter bodies 243, and a bottom portion of the spiral inner ring is communicated with the water outlet 242 of the outer ring body 244. Accordingly, the unfiltered water is guided to flow to the spiral inner ring via the water inlet cover 241, the unfiltered water naturally falls due to the weight thereof, and the nuclear-grade resin filter bodies 243 absorb the impurity of the water, so as to decrease the conductivity o the water.

In the following table, after the water passes the above filter module, the measured data of the water is obtained as follows.

| | | conductivity | | conductivity | decre- |
|---|---|---|---|---|---|
| | initial | before | | after 6 hours | ment |
| water | conductivity | placed | decrement | elapse | ratio |
| source | (uS/cm) | (uS/cm) | ratio (%) | (uS/cm) | (%) |
| tap | 220.0 | 7.21 | 96.72 | 1.45 | 99.34 |
| water | | | | | |

Therefore, from the columns of decrement ratios of the above table, it is obvious that the filter module can decrease the conductivity of the water, and the filtered water can be the same as the pure water.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A hydrogen water generator, having a main body of a substantial T shape, a liquid input end and a hydrogen water output end are respectively disposed on two opposite ends of the main body, and a hydrogen gas input end is disposed between the liquid input end and the hydrogen water output end, wherein, beginning from the liquid input end to the hydrogen water output end, a liquid input section, a pressuring section, a draining and mixing section, a decompressing section and a hydrogen water output section are sequentially formed in the main body, a hydrogen gas input section is formed between the hydrogen gas input end and the draining and mixing section, and a portion which the hydrogen gas input section is connected to the draining and mixing section forms a hydrogen gas inlet; wherein a ratio of a diameter of the liquid input section over a diameter of the draining and mixing section is about 1.5 through 5, and a diameter of the hydrogen water output section is larger than a diameter of the draining and mixing section, a ratio of a length of the draining and mixing section over the diameter of the draining and mixing section is about 1.5 through 5, an inner wall tilting angel of the pressuring section is about 10 through 50 degrees, an inner wall tilting angel of the decompressing section is about 10 through 50 degrees, a ratio of the inner wall tilting angel of the pressuring section over the inner wall tilting angel of the decompressing section is about 1 through 5, wherein a ratio of the diameter of the liquid input section over a diameter of the hydrogen gas inlet is about 3.25 through 650.

2. The hydrogen water generator according to claim 1, wherein the ratio of the diameter of the liquid input section over the diameter of the draining and mixing section is about 2 through 4.

3. The hydrogen water generator according to claim 1, wherein the ratio of the length of the draining and mixing section over the diameter of the draining and mixing section is about 2 through 4.

4. The hydrogen water generator according to claim 1, wherein the inner wall tilting angel of the pressuring section is about 16 through 25 degrees.

5. The hydrogen water generator according to claim 1, wherein the inner wall tilting angel of the decompressing section is about 14 through 25 degrees.

6. The hydrogen water generator according to claim 1, wherein the ratio of the inner wall tilting angel of the pressuring section over the inner wall tilting angel of the decompressing section is about 1 through 1.5.

7. A micro/nano hydrogen bubble water generator, at least comprising a hydrogen gas production device, a water supply device and a hydrogen water generator, the hydrogen water generator comprises a main body, a liquid input end and a hydrogen water output end are respectively disposed on two opposite ends of the main body, and a hydrogen gas input end is disposed between the liquid input end and the hydrogen water output end, wherein, beginning from the liquid input end to the hydrogen water output end, a liquid input section, a pressuring section, a draining and mixing section, a decompressing section and a hydrogen water output section are sequentially formed in the main body, a hydrogen gas input section is formed between the hydrogen gas input end and the draining and mixing section, and a portion which the hydrogen gas input section is connected to the draining and mixing section forms a hydrogen gas inlet; wherein the liquid input end of the hydrogen water generator is connected to the water supply device, the hydrogen gas input end of the hydrogen water generator is connected to the hydrogen gas production device, after water provided by the water supply device flows to the pressuring section via the liquid input section, and is pressured by the pressuring section, the water further flows to the draining and mixing section to be mixed with hydrogen gas which passes the hydrogen gas input section, and after the water mixed with the hydrogen gas passes the decompressing section, and decompressed by the decompressing section, the water is output via the hydrogen water output section and the hydrogen water output end, so as to produce hydrogen water with micro/nano hydrogen bubbles.

8. The micro/nano hydrogen bubble water generator according to claim 7, wherein the water supply device comprises a housing, a water supply tank, a water pump and a water outlet device, the housing is provided to accommodate the hydrogen gas production device, the hydrogen water generator, the water supply tank and the water pump, a water inlet end of the water pump is connected to the water supply tank, a water outlet end of the water pump is connected to the liquid input end of the hydrogen water generator, and the hydrogen water output end of the hydrogen water generator is disposed corresponding to a hydrogen water tank in the housing, wherein the water outlet device is connected to the hydrogen water tank.

9. The micro/nano hydrogen bubble water generator according to claim 7, wherein the water supply device comprises a housing, a water supply tank, a water pump and a water outlet device, the housing is provided to accommodate the hydrogen gas production device, the hydrogen water generator, the water supply tank and the water pump, a water inlet end of the water pump is connected to the water supply tank, a water outlet end of the water pump is connected to the liquid input end of the hydrogen water generator and the water outlet device of the housing, and the hydrogen water output end of the hydrogen water generator is connected to the water supply tank.

10. The micro/nano hydrogen bubble water generator according to claim 7, wherein the hydrogen gas production device comprises a liquid/gas separation module, a proton exchange membrane based hydrogen production module, a power supply and control circuit module and a filter module, the proton exchange membrane based hydrogen production module and the liquid/gas separation module are connected to the filter module, and the liquid/gas separation module is connected to the hydrogen gas input end of the hydrogen water generator.

11. The micro/nano hydrogen bubble water generator according to claim 10, wherein the filter module further comprises a main filter body, a water inlet is disposed on a top portion of the main filter body, a water outlet is disposed on a bottom portion of the filter body, a plurality of nuclear-grade resin filter bodies are disposed in the main filter body, after the water being not filtered flows to the water inlet, and the nuclear-grade resin filter body absorbs impurity of the water and decreases conductivity of the water, the filtered water is supplied to the proton exchange membrane based hydrogen production module.

12. The micro/nano hydrogen bubble water generator according to claim 11, wherein the main filter body further comprises a water inlet cover connected to a water supply end, the water inlet cover further comprises the water inlet; the main filter body further comprises an outer ring body, an inner ring body and a spacing unit, the outer ring body further has an installation space which is provided to combine the inner ring body and the spacing unit, the water outlet is disposed on a bottom portion of the outer ring body, and the water inlet cover is connected to a top portion of the outer ring body; the inner ring body is disposed on the space unit and combined with interior of the installation space, and the spacing unit separates the inner ring body and the outer ring body with a distance; drip holes are disposed on a bottom portion of the inner ring body, the inner ring body is correspondingly combined with a filter fixing plate, a first water filtering space is formed between the filter fixing plate and the water inlet cover, the filter fixing plate and the bottom portion of the inner ring body have a distance therebetween and thus a second water filtering space is formed, the nuclear-grade resin filter bodies are disposed in the second water filtering space.

13. The micro/nano hydrogen bubble water generator according to claim 12, wherein a ratio of a diameter of the outer ring body over a height of the outer ring body is less than 0.9.

14. The micro/nano hydrogen bubble water generator according to claim 12, wherein a diameter of the drip hole of the inner ring body is about 0.8 through 1.5 millimeters.

15. The micro/nano hydrogen bubble water generator according to claim 11, wherein the main filter body further comprises a water inlet cover connected to a water supply end, the water inlet cover further comprises the water inlet, a connection tube is disposed under the water inlet; the main filter body further comprises an outer ring body and an inner ring body; the outer ring body further comprises an installation space which is provided to combine the inner ring body, the water outlet is disposed on a bottom portion of the outer ring body, and further, the water inlet cover is connected to a top portion of the outer ring body; wherein the inner ring body is a spiral inner ring, and the spiral inner ring has a spiral tube, and a top portion of the spiral inner ring is connected to the connection tube, and interior of the spiral inner ring has the nuclear-grade resin filter bodies, a bottom portion of the spiral inner ring is communicated with the water outlet of the outer ring body; wherein the connection tube has a taper section for guiding.

16. A micro/nano hydrogen bubble water production method, at least comprising:
liquid inputting step S11: using a liquid input end of a hydrogen water generator to receive water supplied from a water supply device, such that the water flows to a liquid input section of the hydrogen water generator;
pressuring step S12: when water flows to a pressuring section of the hydrogen water generator via the liquid input section, pressuring the water by using the pressuring section, and making the pressured water flow to a draining and mixing section of the hydrogen water generator;
draining step S13: draining hydrogen gas supplied from a hydrogen gas production device via a hydrogen gas input end of the hydrogen water generator, such that the hydrogen gas passes a hydrogen gas input section of the hydrogen water generator and flows to a draining and mixing section of the hydrogen water generator, thus draining the hydrogen gas into the water for mixing;
decompressing step S14: when the water mixed with the hydrogen gas flows to a decompressing section of the hydrogen water generator via the draining and mixing section, decompressing the water with the hydrogen gas, by using the decompressing section, so as to generate hydrogen water with micro/nano hydrogen bubbles; and
outputting step S15: outputting the hydrogen water with the micro/nano hydrogen bubbles by sequentially passing the hydrogen water output section of the hydrogen water generator and the hydrogen water output end.

17. The micro/nano hydrogen bubble water production method according claim 16, wherein the ratio of the diameter of the liquid input section over the diameter of the draining and mixing section is about 2 through 4.

18. The micro/nano hydrogen bubble water production method according claim 16, wherein the ratio of the length of the draining and mixing section over the diameter of the draining and mixing section is about 2 through 4.

19. The micro/nano hydrogen bubble water production method according claim 16, wherein the inner wall tilting angel of the pressuring section is about 16 through 25 degrees; the inner wall tilting angel of the decompressing section is about 14 through 25 degrees.

20. The micro/nano hydrogen bubble water production method according claim 16, wherein the ratio of the inner wall tilting angel of the pressuring section over the inner wall tilting angel of the decompressing section is about 1 through 1.5.
